(19) United States
(12) Patent Application Publication
(10) Pub. No.: US 2016/0018835 A1
(43) Pub. Date: Jan. 21, 2016

(54) SYSTEM AND METHOD FOR VIRTUAL ENERGY ASSESSMENT OF FACILITIES

(71) Applicant: Retroficiency, Inc., Boston, MA (US)

(72) Inventors: William Hugh Gaasch, Concord, MA (US); Paul J. Gagne, Groton, MA (US); Bryan M. Long, Easton, MA (US); Matthew R. McDaniel, Boston, MA (US); Christopher J. Muth, Boston, MA (US); Joel H. Travis, Watertown, MA (US); Fei Zhao, Cambridge, MA (US)

(21) Appl. No.: 14/335,776

(22) Filed: Jul. 18, 2014

(51) Int. Cl. G05F 1/66; G05B 13/02

(52) U.S. Cl. CPC G05F 1/66; G05B 13/026

(57) ABSTRACT

Embodiments of the invention provide methods and systems to analyze energy consumption and support demand management of a portfolio of facilities. Some embodiments of the invention include a computer implemented method for collecting and cleansing street addresses, time series energy consumption and weather data, classifying energy end-use types, detecting energy related characteristics, creating facility energy models, estimating energy savings potentials and generating customized recommendations for facilities. In some embodiments, the computer-implemented system and method also prioritizes a portfolio of facilities at each stage of the analysis based on facility data quality, level of confidence and energy savings potentials.

### BACKGROUND

Commercial and industrial facilities (“C&I facilities”) account for significant amounts of energy consumption. According to a 2013 report issued by the United States Energy Information Administration (AE02014 Early Release Overview, retrieved from http://www.eia.gov/forecasts/aeo/er/pdf/0383er(2014).pdf), the fraction of energy consumed by C&I facilities is estimated to continuously increase in the foreseeable future. According to “The Program Administrator Cost of Saved Energy for Utility Customer-Funded Energy Efficiency Programs” (by Billingsley, M. A, et al., retrieved from http://emp.lbl.gov/publications/program-administrator-cost-saved-energy-utility-customer-funded-energy-efficiency-progr), energy efficiency represents the most cost-effective way to reduce energy use.

Utilities and efficiency program administrators have been facing the challenge of identifying energy savings opportunities in existing facilities for decades, in large part due to the time-consuming, expensive, and manual process of evaluating efficiency measures, which generally relies on sending engineers on-site to potentially unqualified facilities with cumbersome tools and spreadsheets. Recently, energy consumption data from commercial and industrial facilities has become more accessible due to changes in the markets such as energy deregulation, the advancement of energy efficiency and demand response programs, as well as the development of smart grid technologies. However, technologies that use advanced energy data analytics to provide deeper insights on energy efficiency (especially on a large portfolio of facilities) are still in their infancy. Utilities typically rely on either leads from inbound requests, or simply focus on the biggest energy consumers. Furthermore, the quantity of energy consumed by a customer is typically a poor indicator for actual energy-saving opportunities. For example, even if a facility uses large amounts of energy, it does not mean the facility is energy inefficient. Moreover, other industry standard benchmarks that measure energy-use per unit floor area are not significantly more effective at identifying which facilities have cost-effective efficiency potential.

Thus, there exists a need to provide methods and tools to leverage data analytics throughout the energy efficiency lifecycle. Such desired energy data analytics can be used to identify and prioritize customers with the greatest energy savings potential, engage customers with personalized insights, convert energy audits into efficiency projects, and dynamically track new efficiency opportunities and verify savings.

### SUMMARY

Some embodiments of the invention include a computer-implemented system for remotely assessing energy performance of a plurality of facilities comprising a processor and a non-transitory computer-readable storage medium in data communication with the processor. The non-transitory computer-readable storage medium includes steps executable by the processor for assessing the energy performance, and configured to store locations of the facilities in the non-transitory computer-readable storage medium, and to store time series of facility energy use values at desired interval sizes for energy transference media comprising at least one of electricity, natural gas, steam, hot water, chilled water or fuel oil. The steps executable by the processor are configured to store corresponding outdoor weather values including at least one of dry/wet bulb temperature, humidity, wind speed, cloud coverage, sunrise/sunset time or solar radiation for the same time series periods in the non-transitory computer-readable storage medium. The steps executable by the processor are configured to detect and condition outliers of energy use values using the processor, and classify facility use types based on at least one of facility asset data, tax assessor data, web search results, or time series energy use data patterns using the processor. Further, the steps executable by the processor are configured to detect and quantify characteristics of facilities, including at least one of heating and cooling types, existence of exterior lighting, existence of onsite electricity generation, or time specific operating and occupancy events. The time specific operating and occupancy events comprise at least one of diurnal start and end time of operation, diurnal start and end time of occupancy, or multi-day continuous low occupancy. Further, the steps executable by the processor are configured to generate and store in the non-transitory computer-readable storage medium energy models of a selected subset of the plurality of facilities using detected facility use types and characteristics. In some embodiments, the energy models are used together with time series energy use data and weather data to disaggregate energy end uses of the select facilities. In some further embodiments, the steps executable by the processor are configured to display at least one of estimated energy savings or recommendations by comparing its generated model and an efficient version of the model.

In some embodiments, the computer-implemented system further comprises the processor ranking the plurality of facilities by their data quality to be analyzed in an energy data analytics system. In some further embodiments, the computer-implemented system further comprises the processor implementing a cascaded classification process to classify facility use types. In some embodiments, the classification process comprises using a processor to cleanse and validate the street address of a facility, and if validated, predicting facility use types using a text mining and machine learning method based on relevant text content about the facility. In some embodiments of the invention, the processor predicts facility use types by establishing pattern features and classifiers, and trains learning models to predict use types.

Some embodiments of the invention comprise using hourly or sub-hourly electricity consumption data and daily sunrise or sunset time to detect and quantify the capacity of facility exterior lighting power. Some further embodiments of the invention comprise using hourly or sub-hourly electricity consumption data and selected weather dependent variables with substantially the same day and time schedules to detect and quantify the capacity of supplemental-grid photovoltaic panel or backup generator capacity.

Some further embodiments of the invention comprise ranking a set of facilities with time series energy use data and locations by their data quality to be analyzed in an energy data analytics system. Some embodiments comprise the processor calculating criterion metrics (denoted as xᵢ) including at least one of floor area, EUI, percentage of missing data, percentage of outlier data, percentage of monthly maximum change, day-night ratio, weather correlation goodness-of-fit, number of occupied days, or confidence of facility use type. In some further embodiments, the processor converts each xᵢ to a standardized score using utility function Uᵢ.

Some embodiments of the invention comprise the processor calculating the overall score of a facility, U(x), as U(x)=ΣkᵢUᵢ(xᵢ). Some other embodiments comprise the processor ranking facilities by their overall scores. In some embodiments, the rankings are stored in the non-transitory computer-readable storage medium.

Some embodiments of the invention comprise the processor using hourly or sub-hourly energy use data and corresponding weather data to disaggregate facility end use categories including at least a plurality of heating, cooling, ventilation, pump, interior lighting, exterior lighting, plug loads, domestic hot water, refrigeration, or consistent base load. In some embodiments, the processor uses a per-occupancy-level segmented regression and dynamically generated energy models. In some embodiments, the processor uses a facility-and-system-specific spectral distribution across a portfolio of prior facility energy and weather datasets to identify outlier facilities in the portfolio.

Some embodiments include a computer-implemented method for remotely assessing energy performance of a plurality of facilities comprising using at least one processor to access a non-transitory computer-readable storage medium storing a plurality of steps executable by at least one processor. The steps of the method comprise storing locations of the facilities in the non-transitory computer-readable storage medium, and storing in the non-transitory computer-readable storage medium a time series of facility energy use values at desired interval sizes for usage energy transference media comprising at least one of electricity, natural gas, steam, hot water, chilled water or fuel oil. The steps include storing corresponding outdoor weather values including at least one of dry/wet bulb temperature, humidity, wind speed, cloud coverage, sunrise/sunset time or solar radiation for the same time series periods in the non-transitory computer-readable storage medium. The steps further include detecting and conditioning outliers of energy use values using at least one processor, and classifying facility use types based on at least one of facility asset data, tax assessor data, search engine results, or energy time series data patterns using at least one processor. Further, the steps include using at least one processor to detect and quantify characteristics of facilities, including at least one of heating and cooling types, existence of exterior lighting, existence of onsite electricity generation, or time specific operating and occupancy events, where the time specific operating and occupancy events comprise at least one of diurnal start and end time of operation, diurnal start and end time of occupancy, or multi-day continues low occupancy. Further, the steps include using at least one processor, generating and storing in the non-transitory computer-readable storage medium energy models of a selected subset of the plurality of facilities using collected and detected facility use types and characteristics, and using the energy models to disaggregate energy end uses of the select facilities. In some further embodiments, the steps include displaying at least one of estimated energy savings or recommendations by comparing its generated model and an efficient version of the model.

In some embodiments, the computer-implemented method further comprises at least one processor ranking the plurality of facilities by their data quality to be analyzed in an energy data analytics system. In some embodiments, the computer-implemented method includes at least one processor implementing a cascaded classification process to classify facility use types. In some embodiments of the computer-implemented method, the classification process comprises using at least one processor to cleanse and validate the street address of a facility. If validated, the classification process comprises predicting facility use types using a text mining and machine learning method based on relevant text content about the facility. In some embodiments of the computer-implemented method, if usage data have hourly or sub-hourly resolution, at least one processor predicts facility use types by establishing pattern features and classifiers, and trains learning models to predict use types.

In some embodiments of the computer-implemented method, the classification process further includes at least one processor also predicting facility use types by establishing pattern features and classifiers, and training learning models to predict use types if the usage data has unique patterns. Some further embodiments of the computer-implemented method comprise using hourly or sub-hourly electricity consumption data and daily sunrise or sunset time to detect and quantify the capacity of facility exterior lighting power. Some embodiments of the computer-implemented method further comprise using hourly or sub-hourly electricity consumption data and selected weather dependent variables with substantially the same day and time schedules to detect and quantify the capacity of supplemental-grid photovoltaic panel or backup generator capacity.

Some embodiments of the computer-implemented method further comprise ranking a set of facilities with time series energy use data and locations by their data quality to be analyzed in an energy data analytics system. Some further embodiments of the computer-implemented method comprise at least one processor calculating criterion metrics (denoted as xᵢ) including at least one of floor area, EUI, percentage of missing data, percentage of outlier data, percentage of monthly maximum change, day-night ratio, weather correlation goodness-of-fit, number of occupied days, or confidence of facility use type. Some embodiments of the computer-implemented method comprise at least one processor converting each xᵢ to a standardized score using utility function Uᵢ. Some other embodiments of the computer-implemented method comprise at least one processor calculating the overall score of a facility, U(x), as U(x)=ΣkᵢUᵢ(xᵢ).

Some embodiments of the computer-implemented method comprise at least one processor ranking facilities by their overall scores. Some embodiments of the computer-implemented method comprise storing the rankings in the non-transitory computer-readable storage medium. In some further embodiments, the computer-implemented method includes at least one processor using hourly or sub-hourly energy consumption and corresponding temperature to disaggregate facility end use categories including at least a plurality of heating, cooling, ventilation, pump, interior lighting, exterior lighting, plug loads, domestic hot water, refrigeration, or consistent base load.

Some embodiments of the computer-implemented method comprise at least one processor using a per-occupancy-level segmented regression and dynamically generating the energy model. Some further embodiments of the computer-implemented method further comprise at least one processor using a facility-and-system-specific spectral distribution across a portfolio of prior facility energy and weather datasets to identify outlier facilities in the portfolio.

### DESCRIPTION OF THE DRAWINGS

FIG. 1 is a schematic block diagram of a cloud-based system for virtual energy assessment of a portfolio of facilities, in accordance with embodiments of the invention.

FIG. 2 shows high level steps of a computerized method for virtual energy assessment of a portfolio of facilities, according to embodiments of the invention.

FIG. 3 shows a procedure of data collection, cleansing, retrieval, and consolidation to prepare data for some embodiments of the invention.

FIG. 4 shows a procedure of analyzing facilities by detecting characteristics for some embodiments of the invention.

FIG. 5 illustrates the functions of a “sieve” for filtering data quality of a portfolio of facilities in accordance with some embodiments of the invention.

FIG. 6 shows a method of classifying facility use types based on text results related to the facility, such as facility names and web search results of their street addresses in a web search engine, according to some embodiments of the invention.

FIG. 7 shows a method of classifying facility use types based on patterns of energy use data, according to at least one embodiment of the invention.

FIG. 8 depicts results of a method to automatically cluster time series energy consumption data and generate segmented regressions on each cluster against outdoor air temperature, according to some embodiments of the invention.

FIGS. 9 and 10 illustrate a method to detect and quantify the power capacity of exterior lighting of a facility that has a photo sensor-controlled exterior lighting system with hourly or sub-hourly electricity usage data, according to some embodiments of the invention.

FIG. 11 shows a procedure of processing energy data, generating facility energy models, disaggregating end uses, generating savings and recommendations for facilities, according to some embodiments of the invention.

FIG. 12 shows a procedure of post-processing analysis outcomes of facilities, consisting of quality assurance, visualization and reporting results at both individual facility and whole portfolio levels, according to some embodiments of the invention.

FIG. 13 is a demand map visualization of facility sub-hourly energy use and the concurrent outdoor weather condition in accordance with some embodiments of the invention.

FIG. 14A is an example visualization of facility energy end use disaggregation on an annual basis in accordance with some embodiments of the invention.

FIG. 14B is an example visualization of facility energy end use disaggregation on a monthly basis in accordance with some embodiments of the invention.

FIG. 15 is an example of recommendations display including retrofit recommendations for a facility generated by a virtual energy assessment using the system according to at least one embodiment of the invention.

FIG. 16A is an example visualization of a summer average load demand curve in accordance with some embodiments of the invention.

FIG. 16B is an example visualization of shoulder average load demand curve in accordance with some embodiments of the invention.

FIG. 16C is an example visualization of winter average load demand curve in accordance with some embodiments of the invention.

FIG. 17 is an example visualization of energy use evaluation results of a facility in accordance with some embodiments of the invention.

FIG. 18 is an example overview report of the virtual energy assessment of a facility in accordance with some embodiments of the invention.

FIG. 19A is an example report of energy savings opportunity breakdown of a facility in accordance with some embodiments of the invention.

FIG. 19B is an example report of energy savings opportunity of a facility including annual, lifetime, and peak savings in accordance with some embodiments of the invention.

FIG. 20 is an example analysis report of the virtual energy assessment of a portfolio of facilities in accordance with some embodiments of the invention.

FIG. 21 is an example map visualization of the virtual energy assessment of a portfolio of facilities in accordance with some embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Some of embodiments of the invention as described herein generally relate to obtaining and analyzing energy data of facilities. Some embodiments are more specifically related to prioritization of a portfolio of facilities based on their data quality and energy savings potential. In some embodiments, this is achieved by detecting characteristics from energy data, generating facility energy models, and estimating energy savings of the facilities.

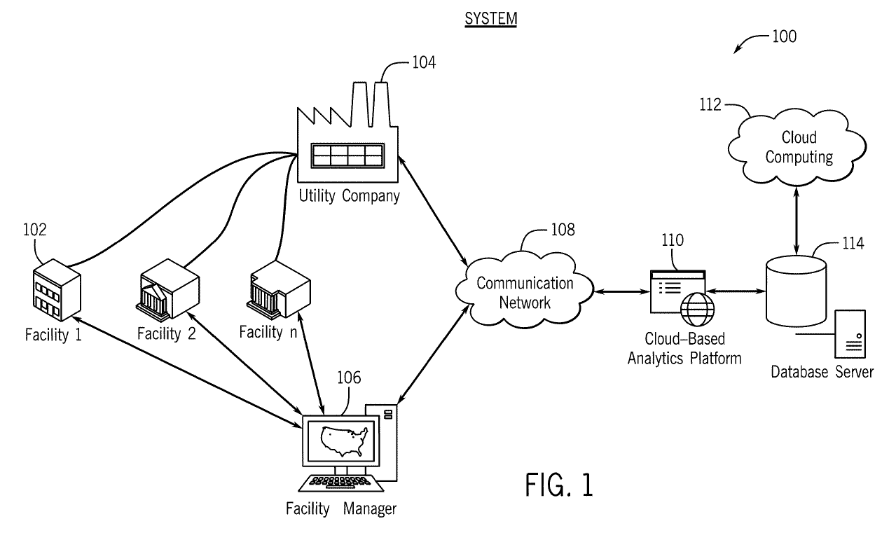

FIG. 1 is a schematic block diagram of a cloud-based system 100 for virtual energy assessment of a portfolio of facilities. In some embodiments, the system can include a cloud-based analytics platform 110. In some embodiments, the platform 110 can include at least one processor coupled to a memory (comprising database server 114). In some embodiments, the platform 110 can also be coupled to a cloud computing infrastructure 112. In some embodiments of the invention, the cloud computing infrastructure 112 can compute and store analytics data remotely from different locations. Further, some embodiments of the invention can comprise a cloud-based analytics platform 110 that can receive time series energy use data with various resolutions from one or more facilities 102 via a communication network 108. In some embodiments, the energy use data can be collected by a utility company 104 that provides energy in energy transference media such as electricity, natural gas, steam, hot water, chilled water, fuel oil, etc. In some embodiments, the energy use data of facilities can be collected by a facility manager 106, or alternatively by similar roles such as an energy service provider or a utility company staff member with access to the cloud-based analytics platform 110. Additionally, in some embodiments, the utility company 104 or the facility manager 106 can also provide supplemental data such as asset data of facilities 102 to the analytics platform 110 via the communication network 108. In some embodiments, after the system 100 completes an analysis, the analytics platform 110 can provide analysis results in a reversed direction back to the facilities 102 via the communication network 108, the utility company 104, or the facility manager 106.

Some embodiments include other data acquisition and delivering methods. For example, in some embodiments, the cloud-based analytics platform 110 can be configured to automatically download energy use data directly from facilities 102. In some embodiments, this can occur through a building management system, a secure file transfer protocol, or an application programming interface via the communication network 108. In some other embodiments, the utility company 104, the facility manager 106, or facilities 102 can send energy use data to the platform 110 in transferable data files (e.g., csv and/or xls file types, etc.).

Several types of data can be collected from facilities 102. For example, some embodiments of the invention enable collection of location data comprising a full street address (e.g., in the form of street, city, state, zip), or partial location such as a zip code, city/county, or geographic coordinates such as latitude and longitude. In some further embodiments, facility asset data can be collected including design and operational characteristics of facilities 102 such as use type, year built, floor area, heating source, types of heating, ventilation and air condition (“HVAC”) systems, occupancy schedule, lighting and plug load intensity, domestic hot water demand, etc. In some further embodiments, energy use data can be collected including series usage values of various energy transference media.

In some embodiments, energy transference media can include media such as electricity, natural gas, steam, hot water, chilled water and fuel oil, in various value types. For example, in some embodiments, the value types can include average, maximum, minimum, average during peak, average during off peak, power factor (of the electricity), and apparent power (of the electricity). In some embodiments, the value types can include values at various time steps such as monthly, daily, hourly and sub-hourly, for a certain duration of time (typically a year), and those that are associated with time stamps. In some other embodiments, weather data can be collected including time series outdoor weather values such as dry/wet bulb temperature, humidity, wind speed, cloud coverage, sunrise/sunset time and solar radiation that is measured from the same period energy data is collected. In some embodiments, energy tariff data can be taken including energy cost structure which could be a flat rate or time of use rates.

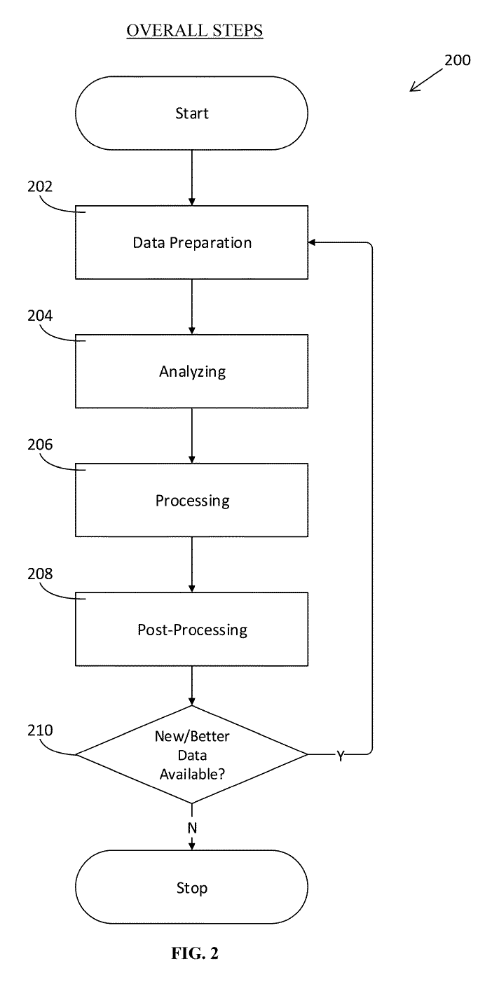

In some embodiments, the system 100 can prepare and process the aforementioned data collected from facilities 102 for use in assessing energy use performance. For example, as shown in FIG. 2, a process 200 can comprise a plurality of steps including a data preparation step 202, leading to an analyzing step 204, leading to a processing step 206, and a subsequent post-processing step 208. Additionally, in some further embodiments, the system 100 can repeat steps 202, 204, 206 and 208 to improve the analysis if newer or better data are available (following a check in step 210).

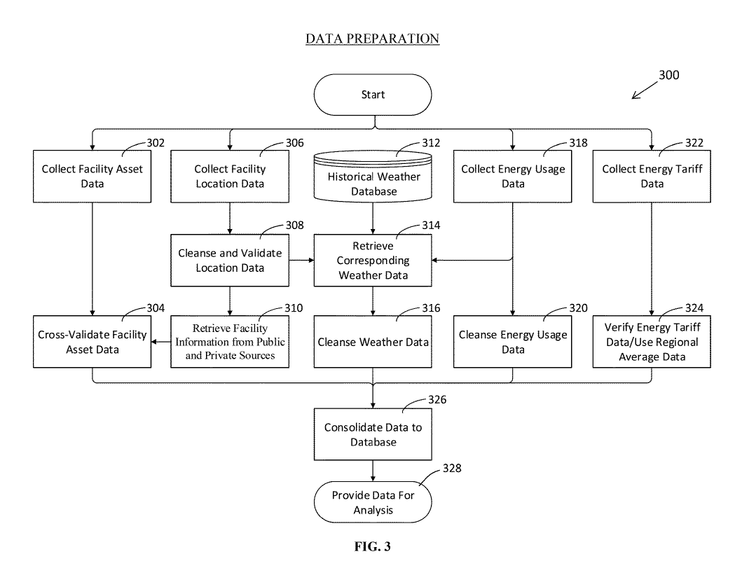

Further, in some embodiments, one or more of the steps 202, 204, 206, 208, 210 can comprise one or more further steps, processes or sub-processes. For example, in some embodiments, the data preparation step 202 can comprise a series of process steps 300 as depicted in FIG. 3. In this example, the process steps 300 can comprise one or more steps or processes that can include a procedure of data collection, data cleansing, data retrieval, and data consolidation to prepare data for some embodiments of invention. In some embodiments, process steps 300 can function to consolidate all relevant data for further analysis. In some embodiments, the data preparation step 202 can comprise process steps 300 that can cleanse and verify the collected data, and consolidate the data to the database 114 in a standard format. For example, in some embodiments, data collection can proceed by collecting various data related to facilities 102, including, but not limited to, collection of facility asset data 302, collecting location data 306, collecting weather data (such as historical weather database 312), collecting energy use data 318, and collecting tariff data 322.

In some embodiments, the data preparation process 300 illustrated in FIG. 3 can comprise collecting or retrieving facility asset data 302. In some other embodiments of the invention, the use of the facility asset data 302 is optional. In some embodiments, the facility asset data 302 can include design and operational characteristics of facilities, such as use type, year built, floor area, heating source, HVAC system types, occupancy schedule, lighting and plug load intensity, domestic hot water demand, etc. In some embodiments, the process 300 can comprise collecting facility location data 306. For instance, specific street addresses in forms such as street number, street name, city, zip code, state/province and country can be collected. In some embodiments, the location data from step 306 can be cleansed and validated in step 308 to ensure they are standardized and valid. In some embodiments, based on cleansed street addresses, facilities can be accurately located from public and private data sources such as geographic information systems (GIS), property tax assessor's databases, real estate databases, etc. In some embodiments, from these private and public data sources, additional facility information can be retrieved in step 310, and cross-validated with collected facility asset data 302 in step 304. In some further embodiments, facility location data collected in step 306 can also include broader areas where the facilities are located such as zip codes, districts, cities, counties or geographic coordinates (e.g., latitudes and longitudes). In some embodiments, when facilities cannot be accurately located from private and public data sources, critical facility asset data such as floor areas have to be collected in step 302.

In some embodiments, the energy use data (collected in step 318) can comprise a time series of facility energy use values, such as electricity consumption, electricity average and/or peak demand, electricity power factor, electricity apparent power, natural gas consumption, steam consumption, hot water consumption, chilled water consumption, fuel oil consumption, etc. In some embodiments, energy use data can be collected at various time steps such as monthly, daily, hourly, and sub-hourly, for certain duration of time, associated with time stamps. As shown in FIG. 3, in some embodiments, following collection of energy use data 318, the energy data can be cleansed in a step 320. In some embodiments, this cleansing can comprise eliminating or correcting outliers using distribution percentage bounds. In some other embodiments, the collected energy use data 318 can be cleansed using time series outlier detection methods such as local polynomial regression, autoregressive integrated moving average (“ARIMA”), autoregressive moving average (“ARMA”), vector auto-regression (“VAR”), cumulative sum (“CUSUM”), or artificial neural networks (“ANN”). In some embodiments of the invention, during the cleansing step 320, several types of outliers can be detected. For example, in some embodiments, outliers such as additive outliers (single outlier observation), innovative outliers (subsequent outlier observations), temporary changes (e.g., day-light savings timestamp shift), global shifts (e.g., constant timestamp shift of the entire meter) can be detected, and synthetic data (e.g., duplicated observation series). In some further embodiments, outlier conditioning options such as inclusions, exclusions, or corrections of detected outliers are determined based on the impacts of outliers to the analysis.

In some embodiments of the invention, regional historical weather data can be collected and stored (either locally or remotely) in a historical weather database 312 prior to the analysis. In some embodiments, based on cleansed and validated location data derived in step 308, and timestamps of energy use data collected in step 318, corresponding weather data can be retrieved from the historical weather database 312 in step 314. In some embodiments, collected weather data 314 can comprise time series outdoor weather values including solar radiation, dry bulb and wet bulb temperature, humidity, wind speed, air pressure, cloud coverage, sunrise and sunset time, among others available in the historical weather database 312. Further, in some embodiments, the weather time is coincident with facility energy use data 318, and weather locations are within acceptable distances to facility locations (e.g., derived from step 308). In some embodiments, weather data (from the historical weather database 312 and/or the collected weather data 314) are also cleansed using statistical methods to eliminate or correct outliers in step 316 (similar to cleansing energy use data in step 320). Further, in some embodiments, the collected energy tariff data 322 can be collected for the cost of energy use. In some embodiments, the collected energy tariff data 322 can be facility specific, distribution zone specific or utility average blended rates per customer size and class. In some further embodiments, the collected energy tariff data 322 for an energy source can be a constant rate, or a dynamic rate structure based on time of use or usage amount of energy. In some embodiments, the collected energy tariff data are also verified by comparing to regional average rates in step 324. Further, in some embodiments, all types of data relevant to facilities 102 are amalgamated into a single database format in step 326 with relevant metadata for processing access, and pushed forward for analyzing in analyzing step 204, and in step 328, provided for processing in the processing phase 206 (see FIG. 2).

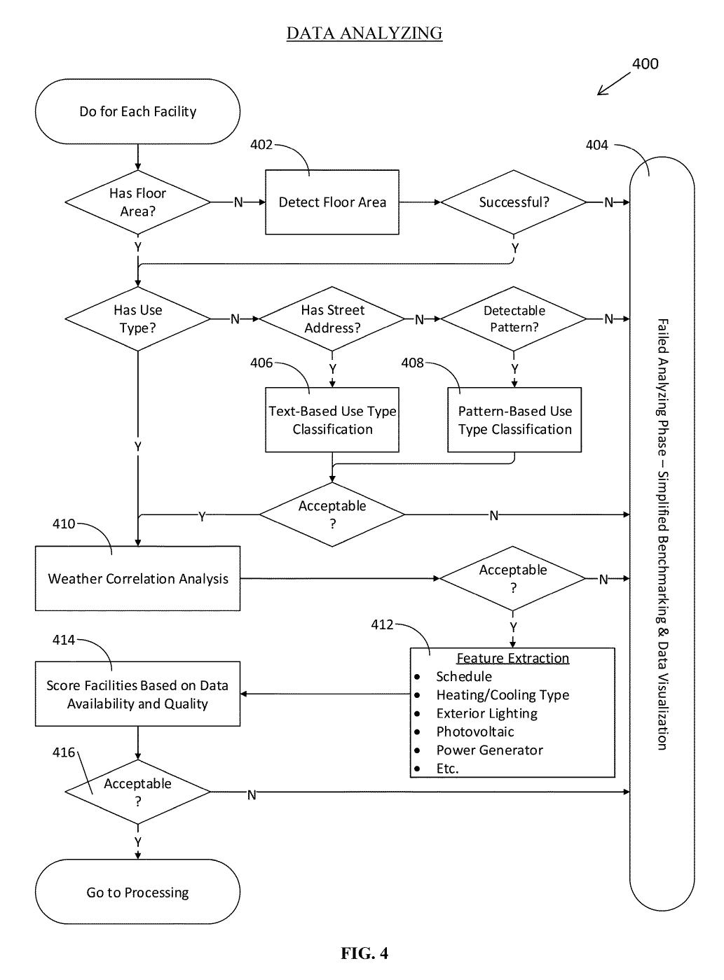

Referring back to FIG. 2, in some embodiments of the invention, the analyzing step 204 can comprise a series of process steps 400 (depicted in FIG. 4). In some embodiments, the analyzing step 204 is the statistical analysis phase of the virtual energy assessment process. In some embodiments of the invention, this phase detects and extracts additional facility information that has not been collected or retrieved in the data preparation step 202. This information can include floor areas, use types, heating and cooling types, as well as other characteristics of facilities in the portfolio (e.g., facilities 102 as depicted in FIG. 1). In some embodiments of the invention, for each facility 102 (in a portfolio), if the floor area is not available after the data preparation phase (data preparation step 202), the system 100 can attempt to detect the floor area in step 402 using the facility's location (see FIG. 4). In some further embodiments, if the facility 102 can be located on a high resolution satellite image that contains the facility 102, the roof area of the facility 102 can be extracted manually from the satellite image, or automatically using image processing and feature extraction algorithms. Similarly, in some further embodiments, if the total number of floors or building height of the facility 102 can be manually or automatically extracted from the satellite image, this information can therefore be used to compute the floor area of the facility 102. However, in some other embodiments, if the facility 102 cannot be accurately located, or high resolution satellite images of the facility 102 are not available, it cannot be analyzed and pushed to the processing step 206 (FIG. 2). As a result, in some embodiments, facilities 102 that are unable to be analyzed are benchmarked with simple metrics such as energy use intensity (hereinafter “EUI”), demand during different periods of days, etc., and visualized in step 404 (FIG. 4). Additionally, in some embodiments, using a scoring method, the analyzing phase 204 works as a facility filtering system that determines which facilities can and cannot be further processed in step 206.

In some embodiments, if a floor area of one or more facilities 102 has been detected successfully in step 402, the system 100 can check if the use type of the facility 102 has been collected in step 202, and if not, the system 100 can attempt to detect it. In some embodiments, when the use type has not been collected, but the street address of the facility is available, a text-based use type prediction system can be applied (step 406). In some embodiments, the text-based prediction system in step 406 can collect text content about the facility 102 from one or more sources (such as its name, description, and web search results), and mine useful information from the text content. More specifically, in some embodiments, the system 100, using the step 406, can train a text mining and machine learning model using text content about facilities 102 with known use types to predict use types of new facilities 102.

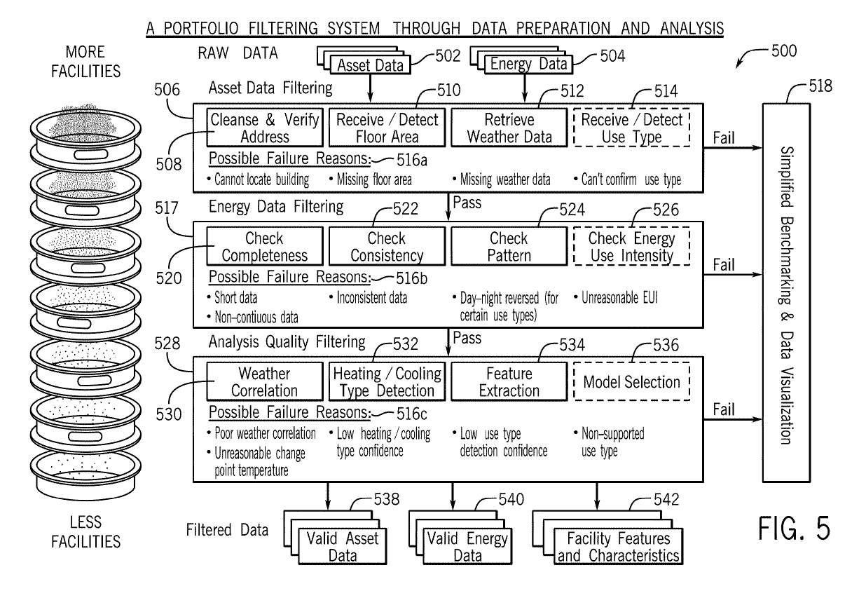

In some further embodiments, filtering processes in data preparation step 202 and the analyzing step 204 shown in FIG. 2 can include a portfolio filtering system through data preparation and analysis. For example, FIG. 5 illustrates the functions 500 of a “sieve” for filtering data quality of a portfolio of facilities 102 in accordance with some embodiments of the invention. In some embodiments, the functions 500 can comprise asset data 502 and energy data 504 that can be fed into an asset data filtering process 506. In some embodiments, data that passes through the asset data filtering process 506 can be fed through an energy data filtering process 517. Further, in some embodiments, data that passes through the energy data filtering process 517 can pass into an analysis quality filtering process 528. In some embodiments, filtered data passing out of the analysis quality filtering process 528 can comprise valid asset data 538, valid energy data 540, and facility features and characteristics data 542. Further, in some other embodiments, data failing to pass through any one of the filtering processes 506, 517, 528 can be processed using simplified benchmarking and data visualization in procedure 518.

In some embodiments, the asset data filtering process 506 can comprise a plurality of steps including a cleansing and verifying address step 508, a receive and/or detect floor area step 510, a retrieve weather data step 512, and receive and/or detect use type step 514. Further, in some embodiments, potential reasons not to pass any of the steps 508, 510, 512, 514 can comprise a possible failure reasons list 516a that can include instances where a facility cannot be located, floor area is missing, weather data is missing, and use type is unconfirmed.

In some embodiments, the energy data filtering process 517 can comprise a plurality of steps including a check completeness step 520, a check consistency step 522, a check pattern step 524, and a check energy use intensity step 526. In some embodiments, potential reasons not to pass any of the steps 520, 522, 524, 526 can comprise a possible failure reasons list 516b that can include short data, non-continuous data, and/or inconsistent data. In some embodiments, other reasons can comprise day and night reversed (for certain use types) and unreasonable EUI.

In some embodiments, the analysis quality filtering process 528 can comprise a series of steps comprising a weather correlation step 530, a heating and/or cooling type detection step 532, a feature extraction step 534, and a model selection step 536. In some embodiments, potential reasons not to pass any of the steps 530, 532, 534, 536 can comprise a possible failure reasons list 516c including poor weather correlation, unreasonable change point temperature, low heating and/or cooling, low use type detection confidence, and/or non-supported use type.

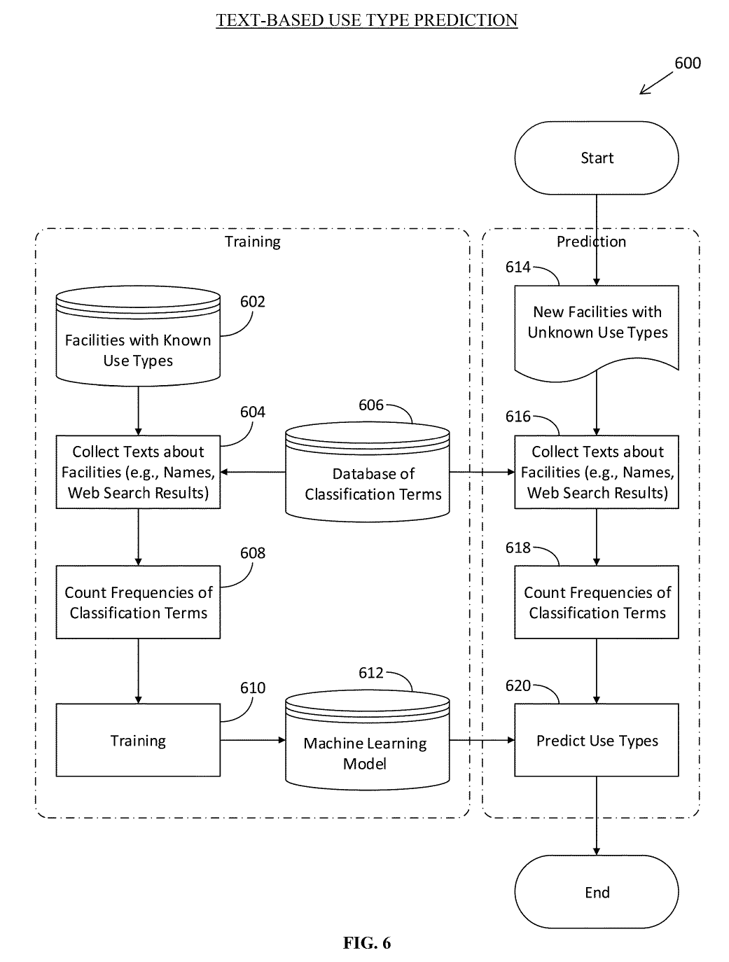

In some embodiments, the process in step 406 of FIG. 4 can comprise the process 600 illustrated in FIG. 6. In some embodiments, when the use type of the facility 102 has not been collected, and text content related to it are also inadequate, a pattern-based use type prediction system (shown as step 408 in FIG. 4) can be applied to detect its use type. In some embodiments, the pattern-based prediction system (step 408) can generate a vector of real-value features for the facility based on its time series energy use data. In some embodiments, the features can include EUI during various time ranges, start/end time of operation and occupancy, and ratios of energy use between various time ranges. In some embodiments, the prediction system (step 408) can then apply classifiers that have been previously trained to this vector of features (by supervised learning algorithms) to predict the most probable use type of the facility 102.

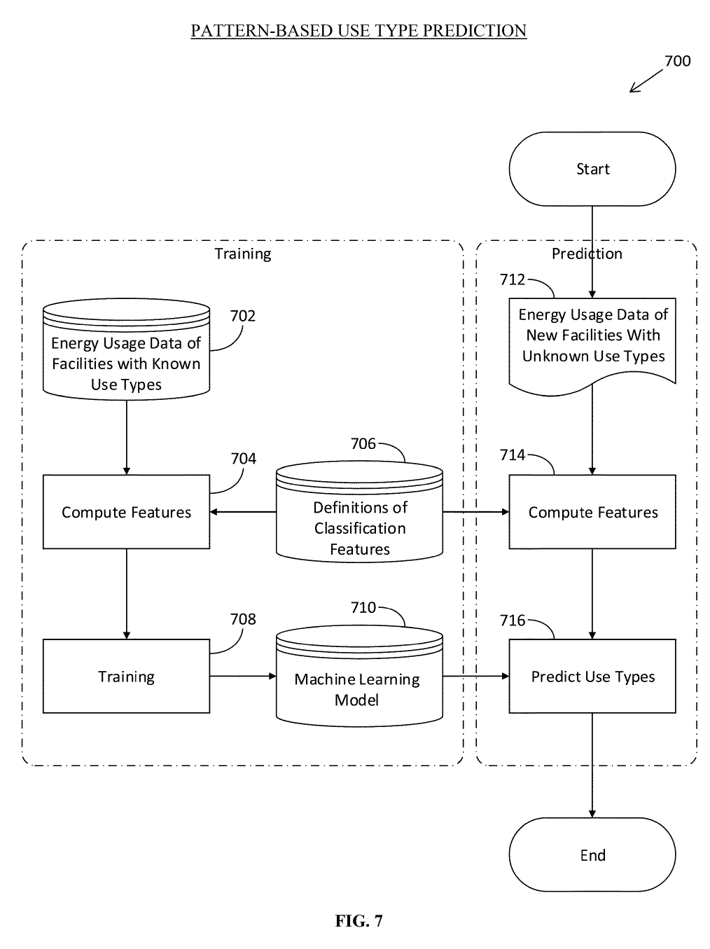

In some embodiments, the process 408 can comprise the process 700 illustrated in FIG. 7. In some embodiments of the invention, if the use type of the facility 102 cannot be detected with an acceptable confidence, it is benchmarked with simple metrics such as EUI, demand during different periods of days, etc., and visualized using step 404. In some further embodiments, if the use type of the facility 102 can be collected in process 202 (FIG. 2), or can be detected with an acceptable confidence in steps 406 or 408 (FIG. 4), the system 100 then performs a segmented regression analysis between the energy use data and weather (e.g., outdoor dry bulb or wet bulb temperature, global horizontal solar radiation, air pressure, wind speed, etc.) in step 410 to determine the facility's energy use weather dependency.

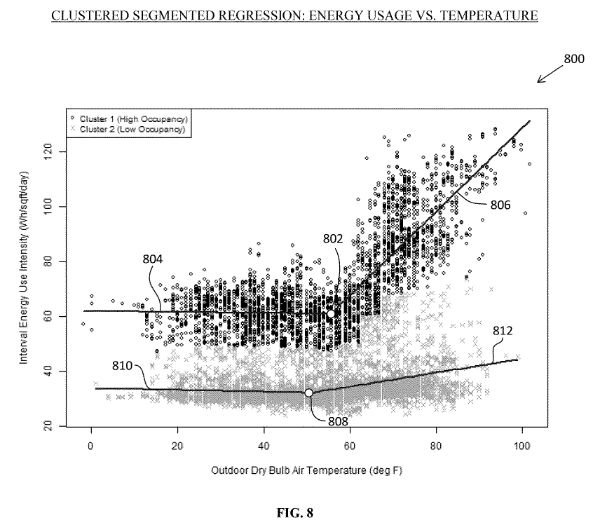

In some embodiments, when the energy use data comprises more than one occupancy level, a clustering algorithm (such as the k-means method) is applied to group energy use intervals by their occupancy levels. For example, FIG. 8 depicts results (depicted in the plot 800) of a method to automatically cluster time series energy use data and generate segmented regression on each cluster against outdoor air temperature. This example embodiment illustrates the energy use data in 15-minute intervals with two clusters of occupancy level. Furthermore, each cluster of intervals and their corresponding dry bulb temperature values are regressed by a segmented linear regression line that has one inflection point in this example. In some other implementations, the segmented linear regression line can have two inflection points between which there is a relatively flat dead band.

Referring again to FIG. 4, in some embodiments of the invention, the system 100 can implement methods comprising a series of steps 400 that include a weather correlation analysis (step 410) that evaluates the quality of regression using performance metrics of goodness-of-fit such as the coefficient of determination (“R²”), the root mean squared error (“RMSE”), and the coefficient of variance of the RMSE (“CVRMSE”). In some embodiments, a facility without an acceptable energy-weather correlation is benchmarked with simple metrics such as EUI, demand during different periods of days, etc., and visualized in step 404. Otherwise, in some embodiments, the facility's energy use data are analyzed through a series of pattern recognition and feature extraction (step 412) to detect characteristics such as occupancy schedule, heating and cooling types, exterior lighting, photovoltaic, power generation, etc.

In some embodiments, after the pattern recognition and feature extraction step 412, the quality of data and analysis of each facility is then scored by a multi-criteria decision analysis (“MCDA”) system in step 414 to rank its usability in the analytics platform. In some embodiments, the MCDA system takes the confidence of outcome from each analysis step previously described in the analyzing phase 204, together with other data consistency and validity metrics from the data preparation phase 202, and considers them as independent criteria. In some embodiments, the metrics can include floor area, EUI, percentage of missing data, percentage of outlier data, percentage of monthly maximum change, day-night ratio, weather correlation goodness-of-fit, number of occupied days, confidence of facility use type, etc. In some embodiments, the metrics (denoted as xᵢ) are then converted into scores, denoted as Uᵢ(xᵢ), using predefined utility functions Uᵢ, and averaged using constant weighting factors kᵢ. Therefore, in some embodiments, the overall score of a facility, denoted as U₍ₓ₎, can be calculated as U(x)=ΣkᵢUᵢ(xᵢ). In a portfolio of facilities 102, facilities 102 that do not fall into step 404 are ranked by their U₍ₓ₎ scores. As a result of the filtering process, in some embodiments, facilities missing key information or with low overall analysis quality are excluded from entering the processing step 206, benchmarked with simple metrics such as EUI, demand during different periods of days, etc., and visualized in step 404.

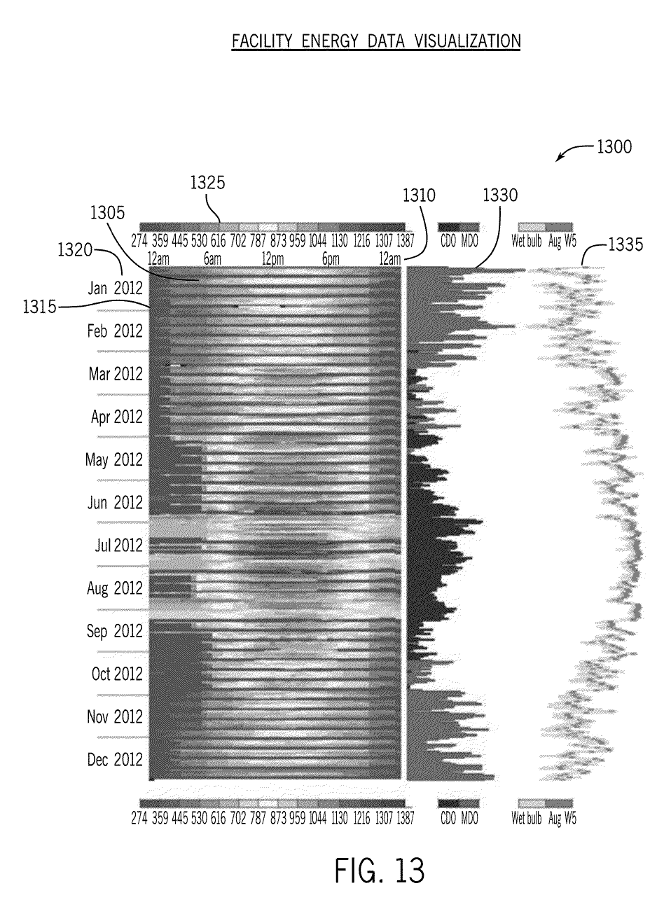

In some further embodiments of the invention, energy use data can be visualized in a high-resolution (e.g., hourly or sub-hourly resolution) in step 404 using the demand map, as shown for example in FIG. 13. In some embodiments, a demand map 1300 can be used to visualize a time series energy use data of a facility 102 to demonstrate its energy response to internal and external factors. The use type of each facility 102 (e.g., office, school, hotel, etc.) can have its own general energy consumption pattern. Further, other factors including controls, equipment efficiency, weather responses, or other power sources can further impact how much energy a facility 102 uses, and a facility's demand map can reflect these characteristics. As depicted in FIG. 13, each pixel 1305 in the demand map 1300 represents an interval of power demand (e.g., 15 minutes, one hour, etc.), and the pixel's color illustrates magnitude of power demand for that time interval (with the x-axis comprising time of day 1310). This is similar to a heat map with the colors mapped to the color bar 1325 representing interval energy demands of their corresponding timestamps. Further, each row 1315 on the demand map 1300 represents one day (with the y-axis comprising date 1320). In some embodiments, by viewing the map from left to right, variations in the facility's daily energy intensity can be illustrated. The first row in the map usually signifies January 1, and the final row usually represents December 31, allowing the viewer to see potential seasonal variations. A second dimension (on the right side of the demand map 1300 in FIG. 13) has been added to depict the heating and cooling degree days 1330 and wet bulb temperature 1335 for the facility's location.

As described earlier, in some embodiments of the invention, the text-based prediction system 406 (comprising the process 600 illustrated in FIG. 6) can collect text content about a facility 102, and a text mining and machine learning model can use the text content with known use types to predict use types of new facilities. As illustrated, in some embodiments, to train the prediction model, the system 100 can use a set of facilities 102 with known use types 602 to build training data. In some embodiments, the system 100 can then retrieve text content about the facilities from varies sources (such as facility names, introductions and descriptions from their websites and public databases, web search results of their addresses, etc.,) in step 604. In some embodiments, the system 100 can then count frequencies of a list of pre-defined classification terms (key words and phrases in the texts from database 606) in step 608. In some embodiments, a collection of paired use types and frequencies of terms of all the facilities 102 can then be used (in step 610) to train a machine learning model 612 to predict facility use types. Various supervised machine learning algorithms can be used in step 610, such as logistic regression, artificial neural network (“ANN”), decision trees and support vector machines (“SVM”).

In some embodiments, to predict the use type of a new facility 102 with unknown use type, the system 100 can first retrieve text content of the facility 102 (step 616), and count the frequencies of the same list of pre-defined terms (from database 606) in the text in step 618. In some embodiments, the system 100 can use the term frequencies and the trained machine learning model 612 to predict the new facility's use type (step 620). In some embodiments, if a many-to-one mapping between all classification terms and use types can be derived (i.e., no term relates to more than one use type), the predicted use type is the one that has the highest overall frequency of mapped terms.

Some embodiments of the invention comprise the pattern-based use type detection system 408 (comprising the process 700 illustrated in FIG. 7) based on the hypothesis that time series energy use data (e.g., 15-minute electricity intervals) have longitudinal patterns that are unique to each facility 102 use type. Therefore, in some embodiments, a machine learning model can be trained using certain features of the energy use data to predict use types of facilities 102 with unknown use types. In some embodiments, to train the prediction model, the system 100 can use data comprising a set of facilities 102 with known use types 702 to build training data. In some embodiments, the system 100 converts the raw time series data into numeric variables (i.e., “features”) that are potentially correlated to use types. In some embodiments, the features can include variables comprising EUI, start/end time of operation and occupancy, distributions of daily usage in each month (e.g., percent occupied), and/or ratios of different usage metrics (maximum, minimum, mean, standard deviation, etc.) of different periods (parts of day, day types, months, seasons, etc.) In some embodiments, the computed features 706 are then evaluated using a variable subset selection algorithm such as a stepwise regression to filter out the most relevant features (in training step 708). In some embodiments, these selected features are then used to train a machine learning model 710 to predict facility 102 use types. In some embodiments, various supervised machine learning algorithms can be used in 710, such as logistic regression, artificial neural network (“ANN”), decision trees and support vector machines (“SVM”).

In some embodiments, to predict the use type of a facility 102 with an unknown use type (step 712), the system 100 first computes its features in step 714 using the definitions of features 706. In some embodiments, the system then uses these features as value inputs in the machine learning model 710 to predict the use type of the facility (in step 716). In some embodiments, regression metrics such as confidence intervals and odds can also be output to determine the confidence of the prediction.

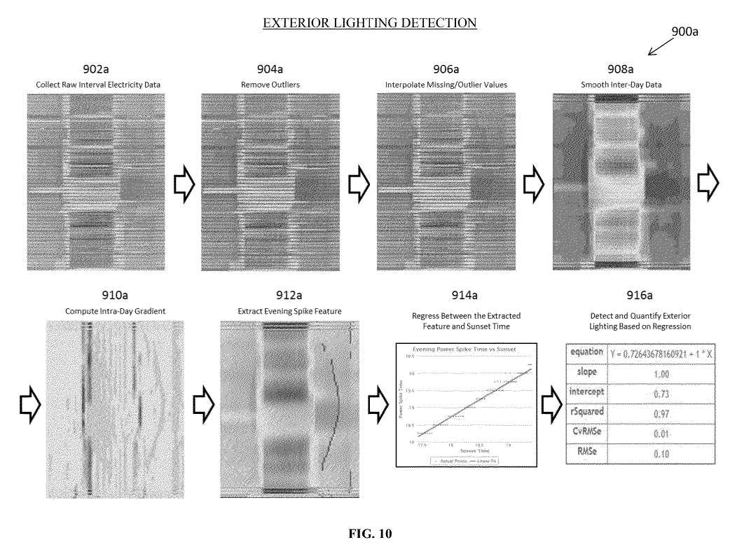

Some embodiments of the invention can comprise analysis including pattern recognition and feature extraction with occupancy schedule detection. For example, in some embodiments, if hourly or sub-hourly energy use data are available, diurnal occupancy levels can be detected based on the rate of change of energy use over time on each day. In some embodiments, a rate of change demand map (such as 910a in FIG. 10) can be generated for the energy use data of a facility 102. In some embodiments, a linear feature extraction can be applied to get the time stamp and magnitude of occupancy increase and decrease. In another embodiment, the start and end of occupancy can be detected by comparing the relative rate of change to a threshold change rate. In some embodiments, if only daily energy use data (total or average consumption data per day) are available, inter-day occupancy levels can be detected by clustering daily points. In some embodiments, a scatter plot of daily energy use against daily average outdoor air temperature (similar to FIG. 8) can be used for the occupancy detection. In some embodiments, clustering methods such as k-means can be applied to determine how many levels (clusters) of occupancy the facility has and which days belong to which level. In some embodiments, this method can be used to distinguish business days, vacation days and holidays. If only monthly energy use data are available, unoccupied or lightly occupied months can be distinguished from normally occupied months. In some embodiments, this method can be used to detect seasonal activities such as the lower occupancy summer months of schools.

Some embodiments of the invention can comprise heating and cooling type detection. In some embodiments, facility 102 energy use data for space heating and cooling are correlated to outdoor air temperature. Further, in some embodiments, correlation analyses such as the segmented linear regression can be performed between energy use and outdoor air temperature for each energy transference medium (e.g., electricity, natural gas, etc.) to determine if this energy transference medium is significantly used for facility heating or cooling. Taking electricity as an example, the plot 800 of FIG. 8 demonstrates an example in which the energy use data are in 15-minute intervals, and have two clusters of occupancy level. In some embodiments, each cluster of intervals and their corresponding dry bulb temperature values are correlated by a segmented linear regression line that has one inflection point (802 for the high cluster and 808 for the low cluster) and two line segments. In the high occupancy cluster, the slope of the line segment with lower temperature (804) can be defined as the heating indicator, and the slope of the line segment with higher temperature (806) can be defined as the cooling indicator. Similarly, in the low occupancy cluster, the slope of the line segment with lower temperature (810) is defined as the heating indicator, and the slope of the line segment with higher temperature (812) is the cooling indicator. In some embodiments, heating and cooling indicators are normalized by facility's floor area and time duration of each interval so that facilities 102 with different sizes and energy metering steps are comparable. In some further embodiments, if the heating indicator of a facility 102 is greater than a threshold, the facility 102 is most likely to have electric heating. On the contrary, in some other embodiments, if the heating indicator is smaller than the threshold, it is less likely to be electrically heated. In some further embodiments, the same approach can be applied to cooling as well.

In some further embodiments, instead of using a deterministic approach, a hypothesis test can be constructed to estimate the confidence of heating and cooling indicators being greater than their thresholds. This can provide the probability of this energy transference medium being used for space heating and cooling. Further, in some embodiments, thresholds of the heating and cooling indicators can be trained using energy use data of facilities 102 with known heating and cooling types. In some embodiments, the thresholds can be different in different climate zones and/or for different use types of each facility 102. Moreover, in some embodiments, the heating and cooling type detection system is not limited to hourly or sub-hourly energy use data, but can be applied to daily or monthly usage data as well.

Some embodiments of the invention can comprise exterior lighting detection. Facility exterior lights with automatic controls are usually turned on routinely, such as around the sunset time or according to a specific timestamp. This can result in a small but constant increase in electricity demand at a constant time t_{diff} before or after that routine time every day. In some embodiments of the invention, this increase in daily electricity demand can be recognized by a series of feature extraction steps, and quantified by a correlation analysis between timestamps of the feature and of sunset. Similarly, in some other embodiments, sunrise time can also be used to detect and quantify exterior lighting.

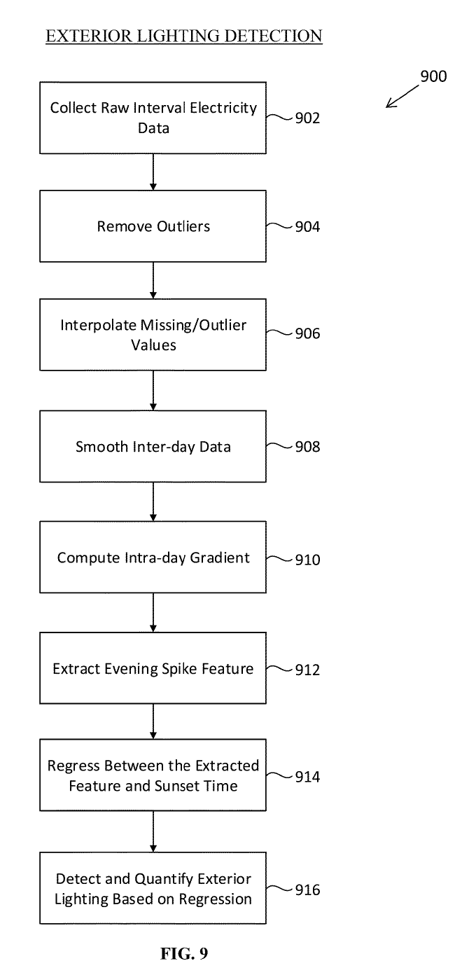

FIGS. 9 and 10 are illustrative of a method to detect and quantify the power capacity of exterior lighting of a facility that has a photo sensor-controlled exterior lighting system with hourly or sub-hourly electricity usage data, according to one embodiment of the invention. For example, in some embodiments, a method can be implemented using the steps 902, 904, 906, 908, 910, 912, 914, 916 of the process 900 shown in FIG. 9. Results of the method can be visualized in the form of corresponding demand maps and results 900a shown in FIG. 10 (shown as 902a for step 902, 904a for step 904, 906a for step 906, 908a for step 908, 910a for step 910, 912a for step 912, 914a for step 914, and 916a for step 916). Referring to the process 900 depicted in FIG. 9, and the corresponding demand maps and results 900a shown in FIG. 10, in some embodiments, after collecting raw interval electricity data in step 902 (plotted as a demand map 902a in FIG. 10), the system 100 can first reduce data noise by removing outliers in step 904 (plotted as a demand map 904a in FIG. 10). Subsequently, in some embodiments, the system 100 can interpolate missing and outlier values in step 906 (plotted as demand map 906a in FIG. 10), and in step 908, smooth inter-day variations vertically on a demand map (shown as a demand map 908a in FIG. 10, and also represented on the demand map 1300 shown in FIG. 13). In some embodiments, the system 100 can then compute intra-day gradient over time in step 910 (shown on the demand map 910a in FIG. 10), and in step 912, extract the highest discrete electricity increase with in a time distance of sunset time on each day (shown on the demand map 912a in FIG. 10). Further, in some embodiments, the timestamps of the extracted daily discrete increases are then compared to daily sunset timestamps in a linear regression with a fixed slope 1 in step 914 (and illustrated in the plot 914a shown in FIG. 10). Further, a step 916 can operate to detect and quantify exterior lighting based on regression. In some embodiments, if the regression returns acceptable goodness-of-fit (e.g., R² or CVRMSE), the system confirms the existence of exterior lighting (example results shown as 916a in FIG. 10). The intercept term in the linear regression is the constant t_{diff} and the mean value of discrete increases is the average capacity of exterior lights.

Some embodiments of the invention can comprise photovoltaic detection. In cases where the hourly or sub-hourly electricity data of a facility 102 are net usage values of consumption and photovoltaic (“PV”) generation, in some embodiments, the PV generation component can be detected and quantified from the net usage data. Unlike electricity consumption, instantaneous PV generation power is not affected by facility operation schedule, but by the solar radiation. Therefore, during days when the facility's occupancy and operational level is close to stable (e.g., weekends for most offices), if the electricity consumption intervals have a strong negative correlation with the local solar radiation (e.g., a close to −1 Pearson's correlation coefficient), this represents strong evidence of the existence of PV. Therefore, in some embodiments, the estimated PV generation capacity and its confidence intervals can be derived from the correlation analysis in some embodiments of the invention.

Some embodiments of the invention can comprise power generator detection. Power generators typically generate electricity using other fuels such as diesel. They are typically turned off and work as a backup power source for special events. In cases where the hourly or sub-hourly electricity data of a facility 102 are net usage values of consumption and power generation, in some embodiments, the existence of generator can be detected using their impacts during regular maintenance tests. These tests are typically performed to turn on power generators periodically for a short period of time (e.g., once a month), usually before the start of occupancy. In some embodiments, these periodical electricity reduction events can be identified and extracted in a similar approach with the exterior lighting detection in process 900 as described earlier.

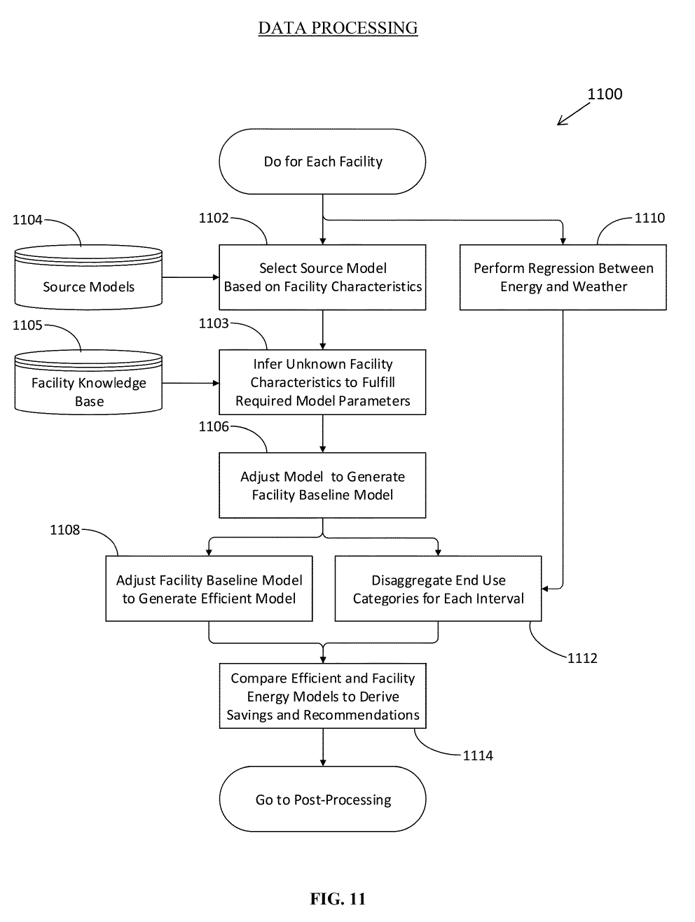

Referring again to FIG. 2, in some embodiments of the invention, once the facilities 102 have been analyzed using the system 100 through the data preparation step 202, the analyzing step 204, and the processing step 206, the system 100 can further process energy data, generate energy models, disaggregate end uses, and generate savings and recommendations for facilities. For example, in some embodiments, the processing step 206 shown in FIG. 2 can comprise the data processing system 1100 illustrated in FIG. 11. In some embodiments, the processing system 1100 can include a database (1104) of source energy models. These source models function as primary starting points for facility energy models. In some embodiments, these source models represent typical design and operational specifications of facilities, considering characteristics such as use types, vintages, HVAC configurations, locations, etc. In some embodiments, they have standardized scalable geometric shapes with various design and operational specifications across multiple vintages and climate conditions.

In some embodiments of the invention, the system 100 first selects (in step 1102) the facility's most similar source model from the source model database 1104 based on the facility's characteristics specified in steps 202 and 204. In some embodiments, in step 1103, the system 100 can then statistically infer unknown facility characteristics to fulfill unknown energy model parameters using known or detected facility characteristics in the previous step 1102 and from the facility knowledge base 1105. In some embodiments, the facility knowledge base 1105 can comprise a collection of facility design and operational parameters and/or their relationships. In some embodiments, the facility knowledge base 1105 can comprise data from one or multiple sources such as actual measurement data, onsite audit reports, previous analysis, public energy surveys, design standards and building codes. In some further embodiments, the facility knowledge base 1105 can also comprise explicit or implicit mathematical relationships between parameters, so that some parameters can be predicted by mathematical operations of some other parameters.

In some embodiments, the system 100 can then proceed to step 1106 to propagate information collected in step 202 (e.g., floor area) and features extracted in step 204 (e.g., occupancy and operational schedules, exterior lighting and PV) can be realized in the energy model to reflect facility specific characteristics. In some embodiments, the facility specific model can be further calibrated to generate the facility baseline model by varying a set of pre-defined input parameters to minimize the energy consumption difference between the model and the facility 102. As a result, steps 1102, 1103 and 1106 generate a baseline energy model that best represents the facility's status quo based on collected facility data, data analytics and prior knowledge about similar facilities.

In some embodiments of the invention, the resulting facility 102 baseline model generated from step 1106 can then be used in two tasks. Firstly, in some embodiments, the baseline model can be manipulated and improved to an efficient model in step 1108 to reflect various energy efficiency measures or to comply with an energy efficiency standard. In some embodiments, the efficient model of step 1108 can then be compared to the facility's energy use data to determine energy savings potential (shown as step 1114). Secondly, in some embodiments, the baseline model generated in step 1106 can be used together with the weather correlation analysis (step 410 in FIG. 4) in step 1110 to disaggregate energy use data by end use categories such as heating, cooling, interior lighting, exterior lighting, plug loads, ventilation, pumps, refrigeration, domestic hot water, other miscellaneous use as well as consistent base load in step 1112. In some embodiments, the end use disaggregation method shown in step 1112 combines posterior evidence derived from the analyzing phase with prior knowledge from the baseline model to generate facility specific end use values for each interval.

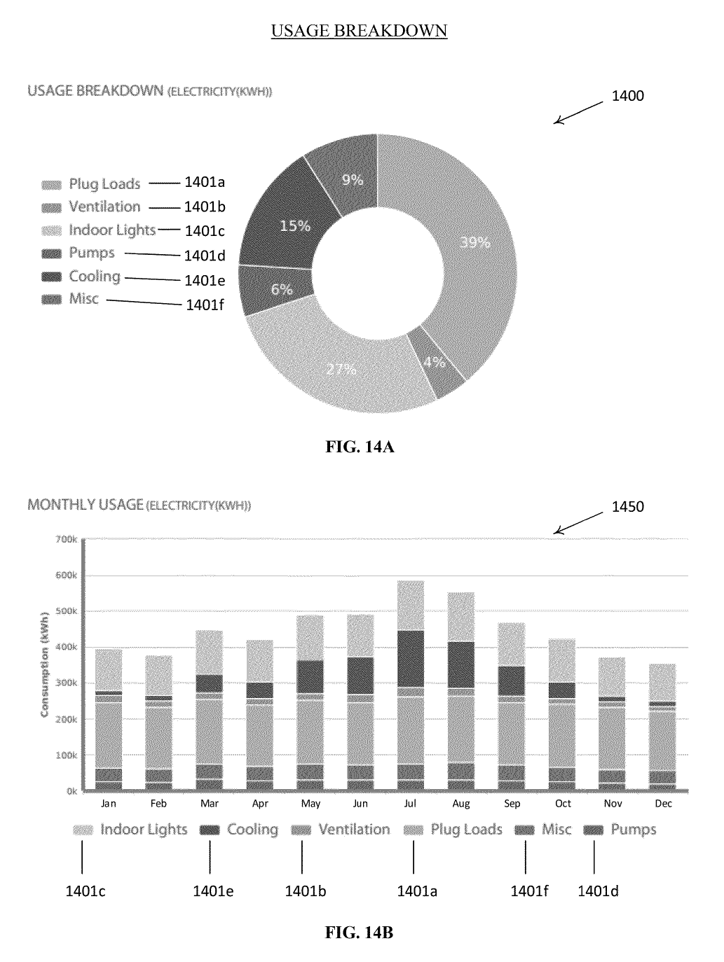

In some embodiments, data generated from the end use disaggregated in step 1112 can be visualized graphically (as in FIGS. 14A-14B). For example, FIG. 14A is an example visualization 1400 of facility energy end use disaggregation on an annual basis in accordance with some embodiments of the invention, and FIG. 14B is an example visualization 1450 of facility energy end use disaggregation on a monthly basis in accordance with some embodiments of the invention. In some embodiments, the visualizations 1400, 1450 can comprise energy end uses such as plug loads 1401a, ventilation 1401b, indoor lights 1401c, pumps 1401d, cooling 1401e, and other miscellaneous use 1401f. In some embodiments, based on the efficient model created in step 1108, and the end use disaggregation estimated in 1112, step 1114 also compares the actual energy use data to the virtual efficient model at specific concurrent time periods on each end use category to derive energy savings potential and generate energy efficiency recommendations. Finally, in some embodiments, the system 100 can move to step 1116 (post-processing step 208 in FIG. 2). In some embodiments, post-processing can comprise analysis and display of recommendations for energy use in a facility 102 and/or any building in a facility 102.

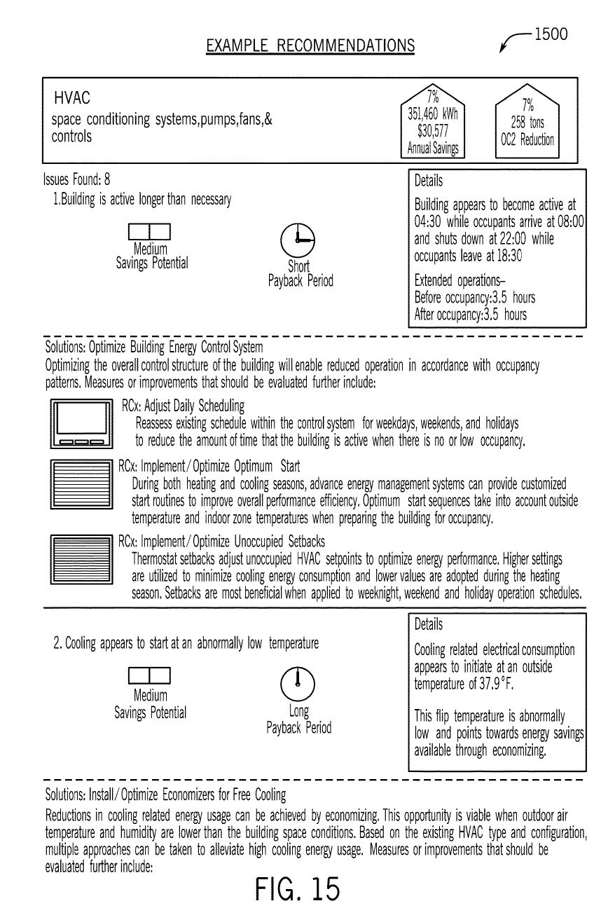

FIG. 15 is an example of recommendations display 1500 including retrofit recommendations for a facility 102 generated by a virtual energy assessment using the system 100 according to at least one embodiment of a method or process as described. As shown, recommendations prepared by the system 100 can include HVAC related information and recommendations including space conditioning systems, pumps, fans, and controls for optimization of heating and cooling of a facility 102.

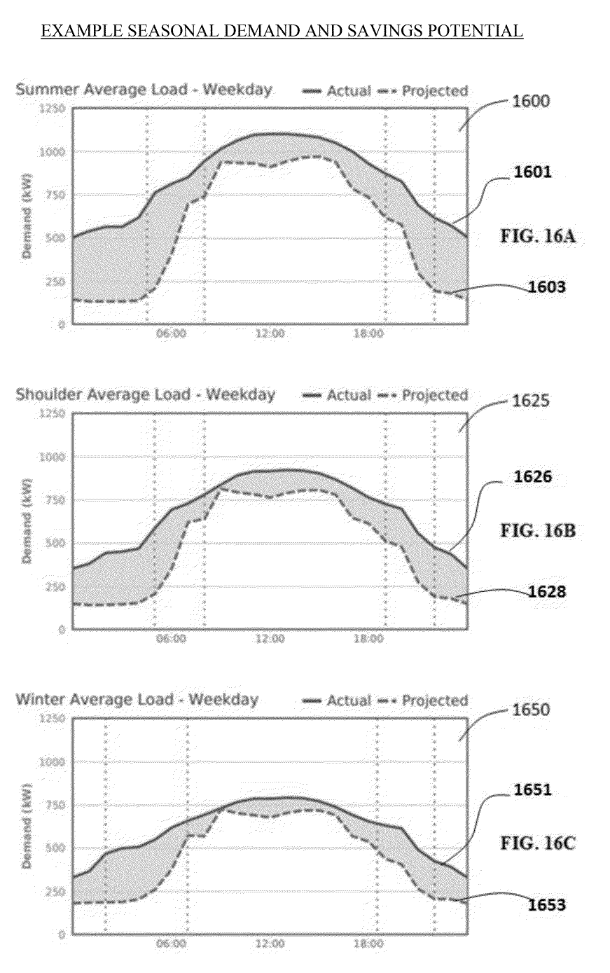

In some embodiments, representative facility load curves for individual energy meters as well as aggregated usage can be created for both actual energy use and for the energy model to visualize energy savings potential at different time periods. For example, FIG. 16A is an example visualization 1600 of a summer weekday average load demand curve 1601, FIG. 16B is an example visualization 1625 of shoulder weekday average load demand curve 1626, and FIG. 16C is an example visualization 1650 of winter weekday average load demand curve 1651 in accordance with some embodiments of the invention. As illustrated, the visualizations 1600, 1625, 1650 can comprise demand curves for actual energy use by the facility (curves 1601, 1626, 1651) and projected energy use (curves 1603, 1628, 1653 respectively) estimated by the efficient energy model.

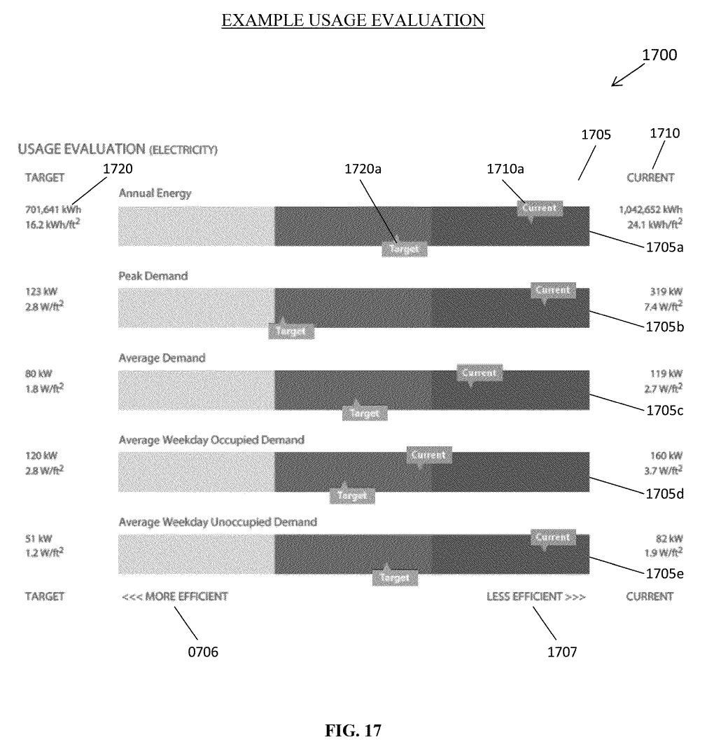

FIG. 17 provides example visualization 1700 of energy use evaluation results of a facility 102 in accordance with some embodiments of the invention. As shown, in some embodiments, the system 100 can display a usage evaluation chart 1705 comprising usage evaluation of electricity comprising an annual energy indicator 1705a, a peak demand indicator 1705b, an average demand indicator 1705c, an average weekday occupied demand indicator 1705d, and an average weekday unoccupied demand indicator 1705e. In some embodiments, a current usage display 1710 and a target usage display 1720 can be displayed for any one indicator 1705a, 1705b, 1705c, 1705d, 1705e representing a target electricity usage and a current electricity usage of any facility 102. Further, in some embodiments, the value of the current usage display 1710 and/or the value of the target usage display 1720 can be displayed on any one of the indicators 1705a, 1705b, 1705c, 1705d, 1705e using a marker and positioned relative to a more efficient end 1706 and a less efficient end 1707 of the indicators 1705a, 1705b, 1705c, 1705d, 1705e. For example, FIG. 17 shows the current usage marker 1710a and the target usage marker 1720a positioned on the annual energy indicator 1705a. In this example, the current usage marker 1710a is positioned on the annual energy indicator 1705a adjacent to the less efficient end 1707, and the target usage marker 1720a is positioned on the annual energy indicator 1705a approximately between the more efficient end 1706 and less efficient end 1707 of the indicator 1705a. The indicator 1705b, 1705c, 1705d, 1705e can also include markers as shown, positioned in various locations reflecting the value of the current usage display 1710 and/or the value of the target usage display 1720.

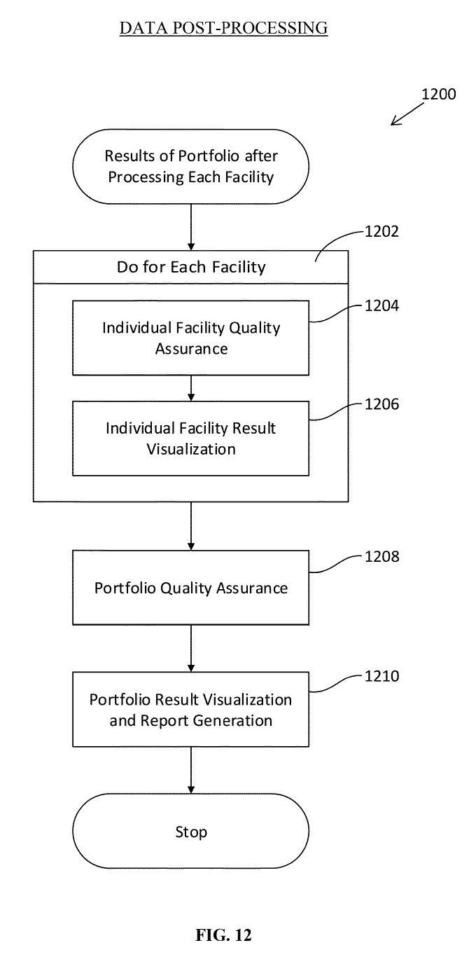

In some embodiments after each facility in a portfolio has been processed in step 206, the portfolio is sent for post-processing in step 208. Referring now to FIG. 12, in some embodiments, the post-processing step 208 (shown in FIG. 2) can comprise the process 1200 shown in FIG. 12. In some embodiments, post-processing is first conducted at a per facility 102 view in processing portion 1202. In some embodiments, for each processed facility 102, the system 100 performs a quality assurance (“QA”) process in step 1204. In some embodiments, this can be based on observed consumption densities across various time slices, as well as derived and inferred characteristics. In some embodiments, the QA process confirms if disparate data sources are in agreement, if data quality is acceptable, and if the baseline model agrees to the actual energy use. In some embodiments, the QA process is performed across all fuels for various time periods. Further, various types of data visualization can be applied to both actual usage and calculated results (step 1206). For example, FIGS. 13, 14A-14B, 15, 16A-16C, and 17 illustrated previously provide some example visualizations useful for the individual facility QA process. In some embodiments, the QA process can also be performed for an entire portfolio in step 1208 to check the potential energy saving spectral distribution of all facilities in the portfolio. Furthermore, in some embodiments, to confirm the distribution of savings for a collection of facilities, the portfolio level QA process can also identify facilities with outlier energy savings, which is often caused by incorrect information, such as wrong floor area or use type. Finally, at the end of the post-processing procedures illustrated in the process 1200, the system 100 can produce a visualization of the virtual energy assessment results of the entire portfolio in step 1210. In some embodiments, various visualization methods can be used to visualize the energy efficiency of a facility 102.

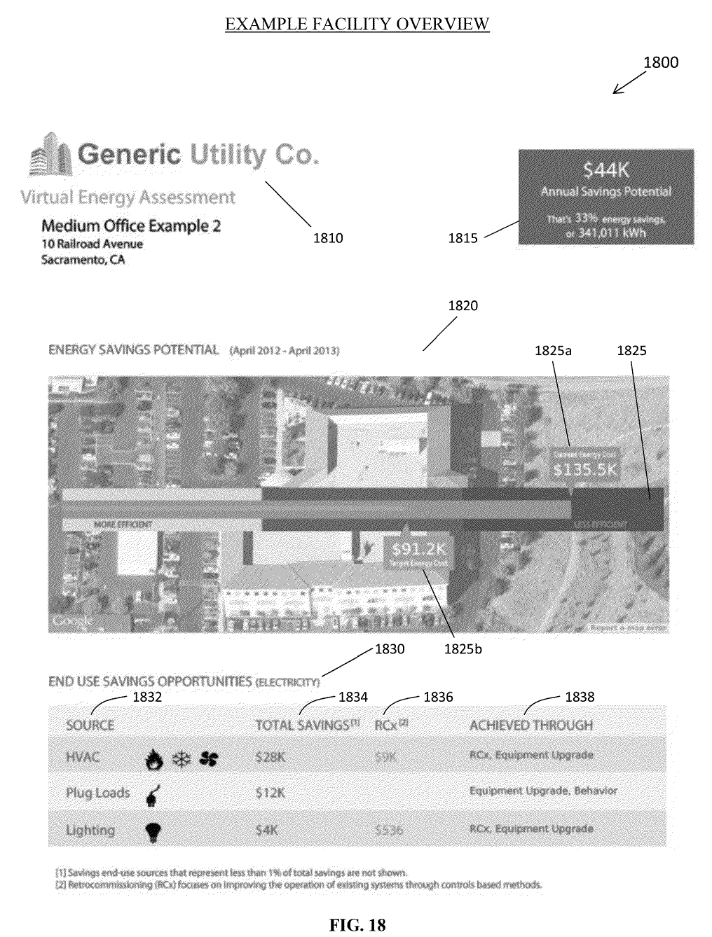

FIG. 18 is an example overview report 1800 of the virtual energy assessment of a facility 102 in accordance with some embodiments of the invention. In some embodiments, the system 100 can generate the facility view display 1800 that can comprise a facility information display 1810 identifying the facility 102. In some embodiments, the facility view display 1800 can include an annual savings display 1815 that can include the energy cost of the annual savings and the amount of energy that the saving represents. Further, in some embodiments, the facility information display 1810 can also include an energy savings potential chart 1820 with a graphical and textual display of energy savings potential. For example, in some embodiments, the energy savings potential chart 1820 can comprise a display bar 1825 with a graphical and textural representation of current energy cost 1825a and target energy cost 1825b. In some further embodiments, the facility view display 1800 can also include an end use savings opportunities display 1830 providing more detailed information on sources of savings, total savings and how further savings can be achieved. For example, in some embodiments, the facility view display 1800 can include a source data column 1832 that can identify one or more sources and a total savings data column 1834 that can display the total savings achievable from each source. Further, in some embodiments, the end use savings opportunities display 1830 can include an “RCx” data column 1836 representing the portion of the savings available from “retrocomissioning”, focusing on improving the operation of existing systems through controls based methods. Further, in some embodiments, the facility view display 1800 can include an “achieved through” information data column 1838 providing information how end use energy savings can be achieved.

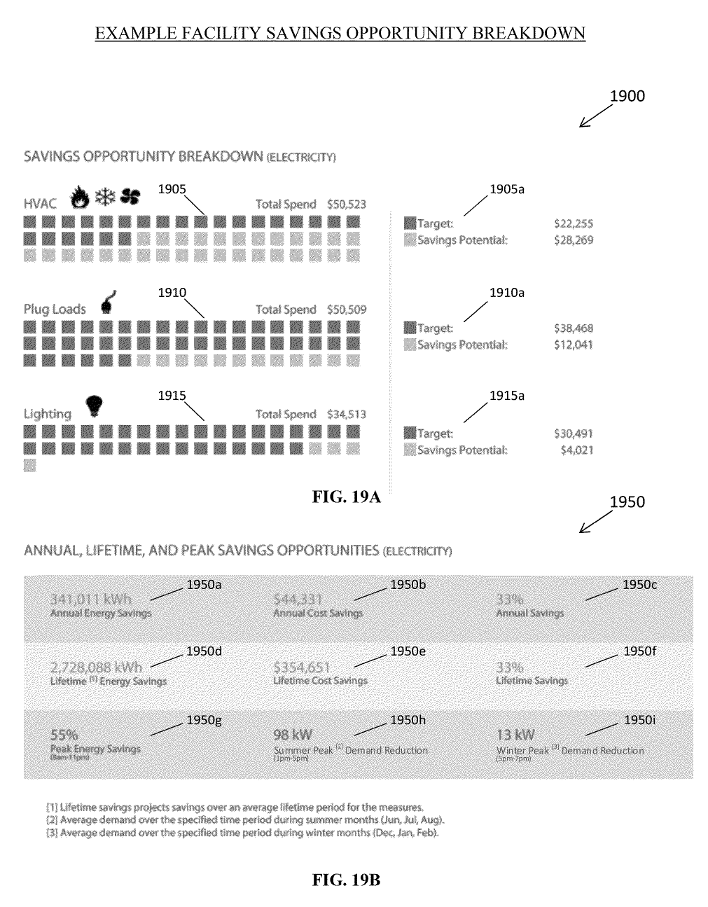

FIG. 19A is an example report (facility savings potential report 1900) illustrative of the energy savings opportunity breakdown of a facility 102 in accordance with some embodiments of the invention. In some embodiments, the report 1900 can include one or more graphical representations of energy savings. For example, in some embodiments, the facility savings potential report 1900 can include a plug loads bar indicator display 1905, a lighting bar indicator display 1910, and an HVAC bar indicator display 1915. Each indicator display can comprise a graphical display representing cumulative total spending and text display of the total spending. Further, in some embodiments, each of the displays 1905, 1910 and 1915 can include associated displays 1905a, 1910a and 1915a respectively providing target and savings potential costs that are mapped to each of the indicator displays 1905, 1910 and 1915.

In some embodiments, the system 100 can display reports comprising annual, lifetime, and peak savings opportunities. For example, FIG. 19B is an example report 1950 of energy savings opportunity of a facility 102 in accordance with some embodiments of the invention. In some embodiments, the report 1950 can comprise annual energy savings 1950a, the annual cost savings 1950b, and the annual savings percentage 1950c of any facility 102. In some further embodiments, the report 1950 can comprise lifetime energy savings 1950d, lifetime cost savings 1950e, and lifetime energy savings percentage 1950f for any facility 102. Further, in some embodiments, the report 1950 can include the peak energy savings percentage 1950g, the summer peak demand reduction 1950h, and the winter peak demand reduction 1950i for any facility 102.

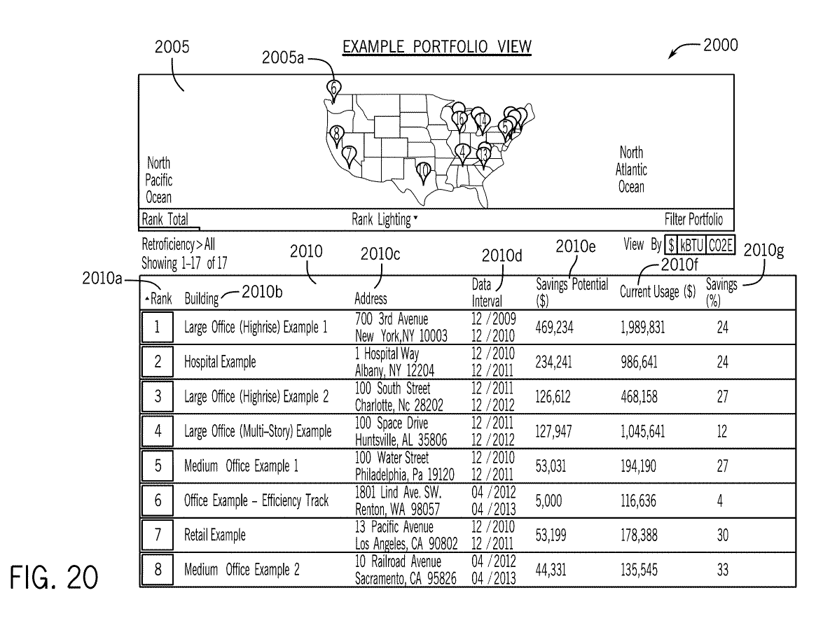

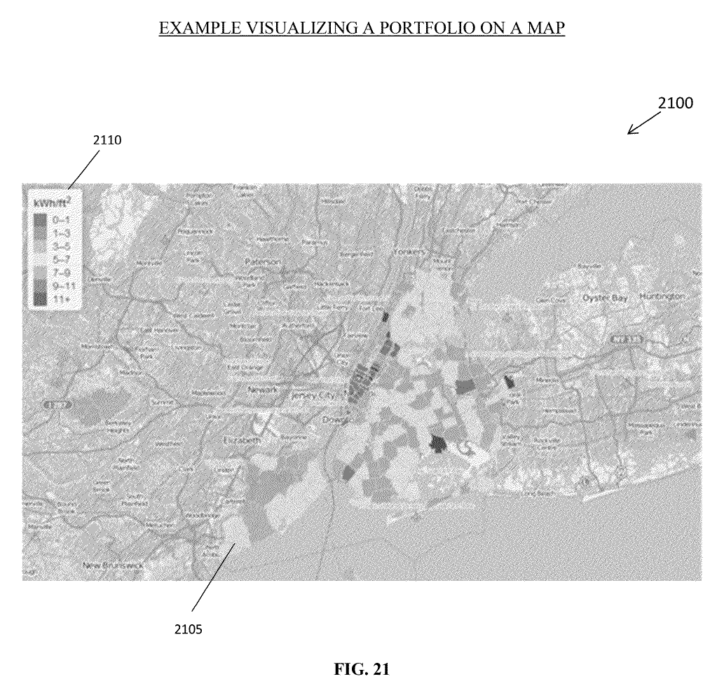

In some embodiments, the system 100 can be configured to calculate and display a virtual energy assessment of a portfolio of facilities 102. For example, FIG. 20 is an example analysis report 2000 of the virtual energy assessment of a portfolio of facilities 102 in accordance with some embodiments of the invention. Further, FIG. 21 illustrates example map visualization 2100 of the virtual energy assessment of a portfolio of facilities 102 in accordance with some embodiments of the invention. In some embodiments, the analysis report 2000 or the intensity map display 2100 can be used to visualize one or more facility related metrics such as EUI, total energy use, and average or peak demand at various spatial and temporal resolutions. Moreover, analytics results such as energy savings potential and demand reduction potential across different temporal resolutions can be plotted for supplementation of actual energy use data visualizations in some embodiments. For example, in some embodiments, the report 2000 can include a map display 2005 comprising a geographical representation of one or more facilities 102. In some embodiments, the report 2000 can also include a report display 2010 providing information related to the energy use and savings potential of any one of the facilities shown in the map display 2005. For example, in some embodiments, the report display 2010 can include a ranking 2010a of a facility 102 correlated to marker 2005a on the map display 2005. Further, the report display 2010 can include facility identifier 2010b, facility address 2010c, and a time (data interval 2010d) over which data from the facility 102 was analyzed by the system 100 to perform the calculations related to energy savings potential. Further, in some embodiments, the report display 2010 can include data for savings potential 2010e, current energy use 2010f, and energy savings percentage 2010g.

In some embodiments, a virtual energy assessment can be provided displayed in a geographical map format. For example, FIG. 21 shows an example map visualization 2100 of the virtual energy assessment of a portfolio of facilities 102 in accordance with some embodiments of the invention. In some embodiments, the map visualization 2100 can display a map over an area (e.g., region, county, municipality, etc.) 2105. In some embodiments, any portion of the area 2105 can comprise a color and/or graphical visualization (representing any specific region, county, or municipality) mapped to an energy use key 2110 that comprises one or more of the color and/or graphical visualizations representations of EUIs.

Referring again to FIGS. 2 and 12, after post-processing a portfolio of facilities, in some further embodiments, the system 100 can check facilities that failed to go through the analysis or failed QA processes 1202 and 1208 (shown in FIG. 12) to see if there are any more reliable or more up-to-date data available, in step 210 (shown in FIG. 2). If yes, the system 100 then repeat steps 202, 204, 206 and 208 to improve the analysis of those facilities. In some embodiments, this can be an iterative process until no improvement can be made.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A computer-implemented system for remotely assessing energy performance of a plurality of facilities, the system comprising:
a processor;
a non-transitory computer-readable storage medium in data communication with the processor, the non-transitory computer-readable storage medium including steps executable by the processor for assessing the energy performance, and configured to:
store locations of the facilities in the non-transitory computer-readable storage medium;
store in the non-transitory computer-readable storage medium a time series of facility energy use values at desired interval sizes for usage energy transference media comprising at least one of electricity, natural gas, steam, hot water, chilled water or fuel oil;
store corresponding outdoor weather values including at least one of dry/wet bulb temperature, humidity, wind speed, cloud coverage, sunrise/sunset time or solar radiation for the same time series periods in the non-transitory computer-readable storage medium;
detect and condition outliers of energy use values using the processor;
classify facility use types based on at least one of facility asset data, tax assessor data, search engine results, or energy time series data patterns using the processor;
detect and quantify characteristics of facilities, including at least one of heating and cooling types, existence of exterior lighting, existence of onsite electricity generation, or time specific operating and occupancy events, where the time specific operating and occupancy events comprise at least one of diurnal start and end time of operation, diurnal start and end time of occupancy, or multi-day continues low occupancy;
generate and store in the non-transitory computer-readable storage medium energy models of a selected subset of the plurality of facilities using detected facility use types and characteristics, and using the energy models to disaggregate energy end uses of the select facilities; and
display at least one of estimated energy savings or recommendations for each select facility by comparing its generated model and an efficient version of the model.

2. The computer-implemented system of claim 1, further comprising the processor ranking the plurality of facilities by their data quality to be analyzed in an energy data analytics system.

3. The computer-implemented system of claim 1, wherein the processor implements a cascaded classification process to classify facility use types.

4. The computer-implemented system of claim 3, wherein the classification process comprises using a processor to cleanse and validate the street address of a facility, and if validated, predicting facility use types using a text mining and machine learning method based on relevant text content about the facility.

5. The computer-implemented system of claim 3, wherein if usage data have hourly or sub-hourly resolution, the processor predicts facility use types by establishing pattern features and classifiers, and trains learning models to predict use types.

6. The computer-implemented system of claim 5, wherein the classification process further includes the processor also predicting facility use types by establishing pattern features and classifiers, and training learning models to predict use types if usage data have unique patterns.

7. The computer-implemented system of claim 1, further comprising using hourly or sub-hourly electricity consumption data and daily sunrise or sunset time to detect and quantify the capacity of facility exterior lighting power.

8. The computer-implemented system of claim 1, further comprising using hourly or sub-hourly electricity consumption data and selected weather dependent variables with substantially the same day and time schedules to detect and quantify the capacity of supplemental-grid photovoltaic panel or backup generator capacity.

9. The computer-implemented system of claim 1, further comprising ranking a set of facilities with time series energy use data and locations by their data quality to be analyzed in an energy data analytics system.

10. The computer-implemented system of claim 1, further comprising the processor calculating criterion metrics (denoted as xᵢ) including at least one of floor area, EUI, percentage of missing data, percentage of outlier data, percentage of monthly maximum change, day-night ratio, weather correlation goodness-of-fit, number of occupied days, or confidence of facility use type.

11. The computer-implemented system of claim 10, further comprising the processor converting each xᵢ to a standardized score using utility function Uᵢ.

12. The computer-implemented system of claim 11, further comprising the processor calculating the overall score of a facility, U(x), as U(x)=ΣkᵢUᵢ(xᵢ).

13. The computer-implemented system of claim 12, further comprising the processor ranking facilities by their overall scores.

14. The computer-implemented system of claim 13, wherein the rankings are stored in the non-transitory computer-readable storage medium.

15. The computer-implemented system of claim 1, further comprising the processor using hourly or sub-hourly energy consumption and corresponding temperature to disaggregate facility end use categories including at least a plurality of heating, cooling, ventilation, pump, interior lighting, exterior lighting, plug loads, domestic hot water, refrigeration, or consistent base load.

16. The computer-implemented system of claim 1, further comprising the processor using a per-occupancy-level segmented regression and dynamically generating the energy model.

17. The computer-implemented system of claim 1, further comprising the processor using a facility-and-system-specific spectral distribution across a portfolio of prior facility energy and weather datasets to identify outlier facilities in the portfolio.

18. A computer-implemented method for remotely assessing energy performance of a plurality of facilities comprising:
using at least one processor to access a non-transitory computer-readable storage medium storing a plurality of steps executable by at least one processor, the steps comprising:
storing locations of the facilities in the non-transitory computer-readable storage medium;
storing in the non-transitory computer-readable storage medium a time series of facility energy use values at desired interval sizes for usage energy transference media comprising at least one of electricity, natural gas, steam, hot water, chilled water or fuel oil;
storing corresponding outdoor weather values including at least one of dry/wet bulb temperature, humidity, wind speed, cloud coverage, sunrise/sunset time or solar radiation for the same time series periods in the non-transitory computer-readable storage medium;
detecting and conditioning outliers of energy use values using at least one processor;
classifying facility use types based on at least one of facility asset data, tax assessor data, search engine results, or energy time series data patterns using at least one processor;
using at least one processor, detecting and quantifying characteristics of facilities, including at least one of heating and cooling types, existence of exterior lighting, existence of onsite electricity generation, or time specific operating and occupancy events, where the time specific operating and occupancy events comprise at least one of diurnal start and end time of operation, diurnal start and end time of occupancy, or multi-day continues low occupancy;
using at least one processor, generating and storing in the non-transitory computer-readable storage medium energy models of a selected subset of the plurality of facilities using detected facility use types and characteristics, and using the energy models to disaggregate energy end uses of the select facilities; and
displaying estimated energy savings and recommendations for at least one by comparing its generated model and an efficient version of the model.

19. The computer-implemented method of claim 18, further comprising at least one processor ranking the plurality of facilities by their data quality to be analyzed in an energy data analytics system.

20. The computer-implemented method of claim 18, wherein at least one processor implements a cascaded classification process to classify facility use types.

21. The computer-implemented method of claim 20, wherein the classification process comprises using at least one processor to cleanse and validate the street address of a facility, and if validated, predicting facility use types using a text mining and machine learning method based on relevant text content about the facility.

22. The computer-implemented method of claim 20, wherein if usage data have hourly or sub-hourly resolution, at least one processor predicts facility use types by establishing pattern features and classifiers, and trains learning models to predict use types.

23. The computer-implemented method of claim 22, wherein the classification process further includes at least one processor also predicting facility use types by establishing pattern features and classifiers, and training learning models to predict use types if usage data have unique patterns.

24. The computer-implemented method of claim 1, further comprising using hourly or sub-hourly electricity consumption data and daily sunrise or sunset time to detect and quantify the capacity of facility exterior lighting power.

25. The computer-implemented method of claim 1, further comprising using hourly or sub-hourly electricity consumption data and selected weather dependent variables with substantially the same day and time schedules to detect and quantify the capacity of supplemental-grid photovoltaic panel or backup generator capacity.

26. The computer-implemented method of claim 1, further comprising ranking a set of facilities with time series energy use data and locations by their data quality to be analyzed in an energy data analytics system.

27. The computer-implemented method of claim 1, further comprising at least one processor calculating criterion metrics (denoted as xᵢ) including at least one of floor area, EUI, percentage of missing data, percentage of outlier data, percentage of monthly maximum change, day-night ratio, weather correlation goodness-of-fit, number of occupied days, or confidence of facility use type.

28. The computer-implemented method of claim 27, further comprising at least one processor converting each xᵢ to a standardized score using utility function Uᵢ.

29. The computer-implemented method of claim 28, further comprising at least one processor calculating the overall score of a facility, U(x), as U(x)=ΣkᵢUᵢ(xᵢ).

30. The computer-implemented method of claim 29, further comprising at least one processor ranking facilities by their overall scores.

31. The computer-implemented method of claim 30, wherein the rankings are stored in the non-transitory computer-readable storage medium.

32. The computer-implemented method of claim 1, further comprising at least one processor using hourly or sub-hourly energy consumption and corresponding temperature to disaggregate facility end use categories including at least a plurality of heating, cooling, ventilation, pump, interior lighting, exterior lighting, plug loads, domestic hot water, refrigeration, or consistent base load.

33. The computer-implemented method of claim 1, further comprising at least one processor using a per-occupancy-level segmented regression and dynamically generated energy models.

34. The computer-implemented method of claim 1, further comprising at least one processor using a facility-and-system-specific spectral distribution across a portfolio of prior facility energy and weather datasets to identify outlier facilities in the portfolio.
